(19) United States
(12) Patent Application Publication
(10) Pub. No.: US 2023/0338839 A1
(43) Pub. Date: Oct. 26, 2023

(54) SYSTEM AND METHOD FOR MONITORING GAMEPLAY USING AN APPLICATION PROGRAM INTERFACE

(71) Applicant: CHALK ESPORTS, INC., San Diego, CA (US)

(72) Inventors: Michael Ray GARNICA, San Diego, CA (US); Nicholas Andrew SAPONARO, San Diego, CA (US); Kent OKAZAKI, San Diego, CA (US); Logan Williams BERTRAND, San Diego, CA (US)

(21) Appl. No.: 17/724,989

(22) Filed: Apr. 20, 2022

(51) Int. Cl. A63F 13/46; A63F 13/75; A63F 13/792; A63F 13/795

(52) U.S. Cl. CPC A63F 13/46; A63F 13/75; A63F 13/792; A63F 13/795

(57) ABSTRACT

The technology described in this application relates to a system and method for using an API for a video game application where the data from the API can be used in various processes and sub-processes. For example, the technology allows a system to create a tournament for a game (e.g., a multiplayer first person shooter game) where data obtained via an API can be used for measuring player participating in the tournament. The technology described herein can also utilize a technique for continuously making API calls without the risk of the API system denying a request (e.g., due to too many frequent API call attempts, due to too many requests made from a single network address).

### CROSS REFERENCE TO RELATED APPLICATION(S)

None

### BACKGROUND AND SUMMARY

Video game system(s) have existed for decades. For many years, users could play the games with each other by going to arcades, or playing in local environments using different game console systems. With the evolution of the internet, network gameplay between disparate users has become commonplace. Indeed, the gaming industry has become vast and complex, allowing gamers across the globe to compete with each other in virtual competition.

Certain technology exists for interfacing with various application systems (e.g., game systems) in order to execute an application process associated with the application system. For example, application program interface(s) (API) systems allow an entity to “open up” their applications’ data and functionality to external third-party developers, business partners, and internal departments within their companies. This allows services and products to communicate with each other and leverage each entity’s data and functionality through a documented interface.

As a non-limiting example, APIs can thus allow gaming companies to open up certain gaming applications for developers to access data associated with the application. However, conventional technology has certain drawbacks with developers/users using the APIs to access various data. For example, certain API technology may have various “built-in” limits for accessing/calling the API (e.g., can only access a maximum number of times in a given period, access attempts restricted by user network address) thus causing a developer system to make unnecessary requests that waste processing resources of the system, and also waste system bandwidth.

Moreover, conventional technology for online gaming allows players to join multiplayer gaming environments. Certain conventional technology also allows users to join tournaments (that could include one or more “pools”) for competing in the multiplayer gaming environments with other users. However, the conventional technology is very rigid and typically requires users to visit web-sites to find out when a game is being played, and then a user may have to report (or upload) gaming results in order to compete in the pool/tournament thus affecting the user experience with the system.

Accordingly, it will be appreciated that new and improved techniques, systems, and processes are continually sought after.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BRIEF DESCRIPTION OF THE DRAWINGS

FIG. 1 depicts a non-limiting example block diagram of a system;

FIG. 2 depicts a non-limiting example block diagram of software components included in the exemplary system;

FIG. 3 shows a non-limiting timing diagram of various components in a system;

FIG. 4 shows a non-limiting example data structures;

FIGS. 5A-D show non-limiting example flowcharts depicting processes carried out in association with the system;

FIGS. 6A-G show non-limiting example user interfaces associated with the system; and

FIG. 7 shows a non-limiting example block diagram of hardware components comprising the system.

### DETAILED DESCRIPTION OF THE TECHNOLOGY

### Selected Definitions

When it is described in this document that an action “may,” “can,” or “could” be performed, that a feature or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, component, attribute, etc. is present in at least one embodiment, though is not necessarily present in all embodiments.

As used in this document, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage.

As used in this document, the term “and/or” includes any and all combinations of one or more of the associated listed items.

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

### Overview

The technology described herein relates to, among other topics, a system for monitoring an application (e.g., video game) using an API(s). The technology described herein also relates to a system for generating a gaming process (e.g., tournament) associated with one or more online video games.

As discussed herein, API technology allows for an entity to provide access to a developer for obtaining data associated with an application. Typically, a client may initiate a request for retrieving information (e.g., through the API call). This request is processed from an application to the web server via the API’s Uniform Resource Identifier (URI) and can include a request verb, headers, and a request body. After receiving a valid request, the API makes a call to the external program or web server, where the server sends a response to the API with the requested information. The API can then transfer the data to the initial requesting application.

The technology described herein can use an API for a video game application (or any other application) where the data from the API can be used in various processes and sub-processes. For example, the technology allows a system to create a tournament for a game (e.g., a multiplayer first person shooter game) where data obtained via an API can be used for measuring player participating in the tournament. In doing so, the system advantageously improves the overall user experience associated with the system(s) thus improving the overall human-computer interface.

The technology described herein can also utilize a technique for continually altering a network address (e.g., via a cloud service system) in order to continuously make API calls without the risk of the API system denying a request (e.g., due to too many frequent API call attempts, due to too many requests made from a single network address). In doing so, the system advantageously reduces unnecessary requests made between devices in the system thus improving communication bandwidth/latency.

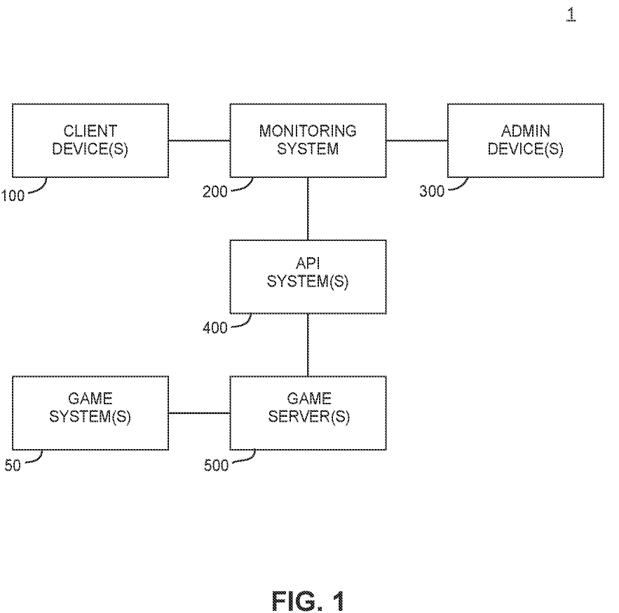

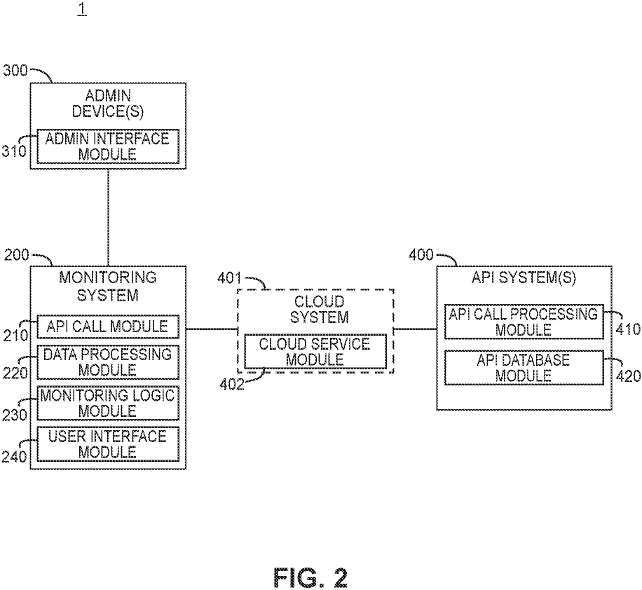

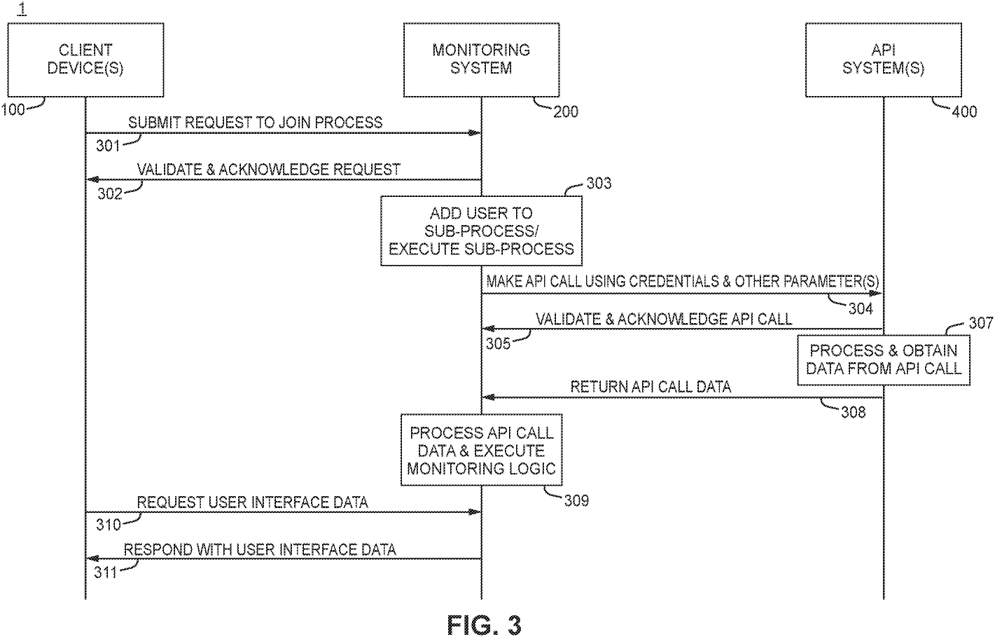

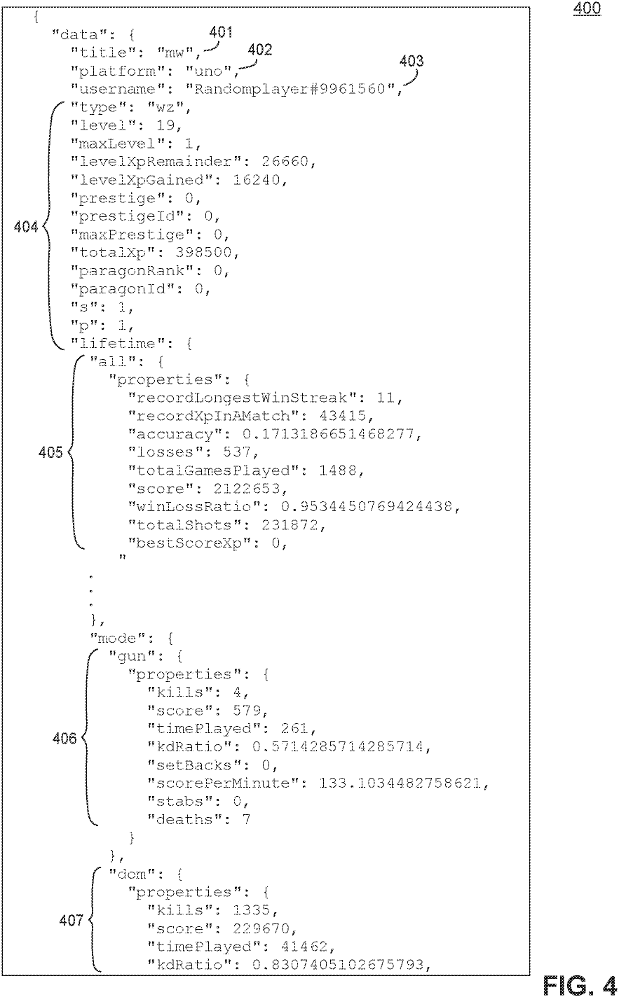

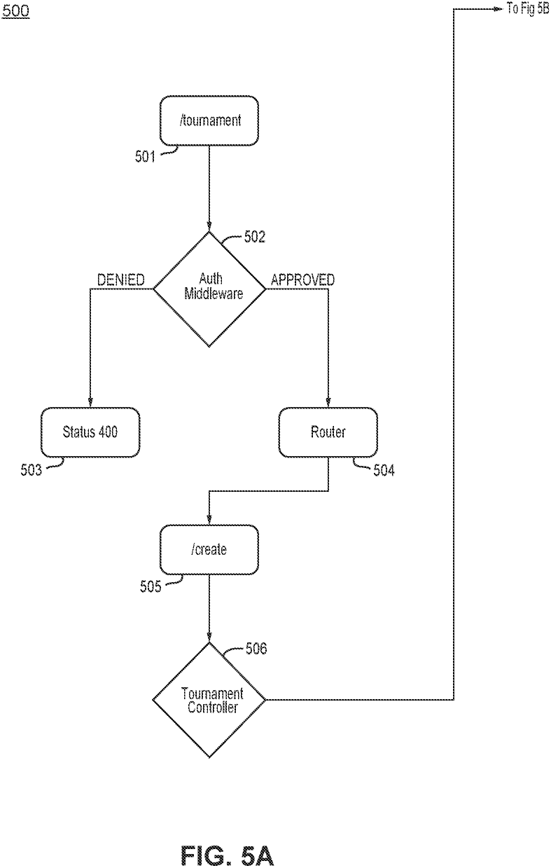

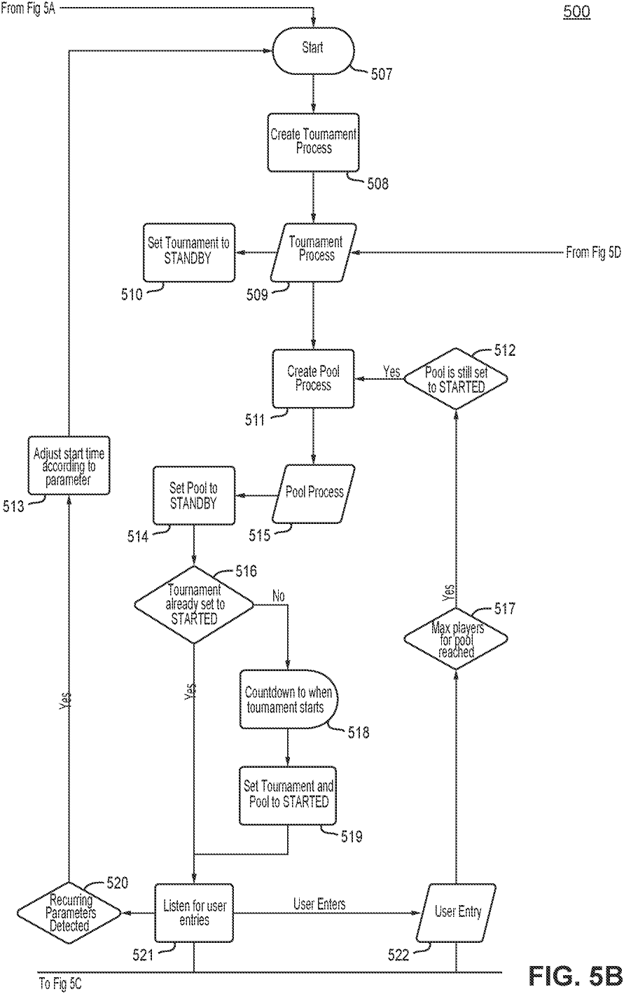

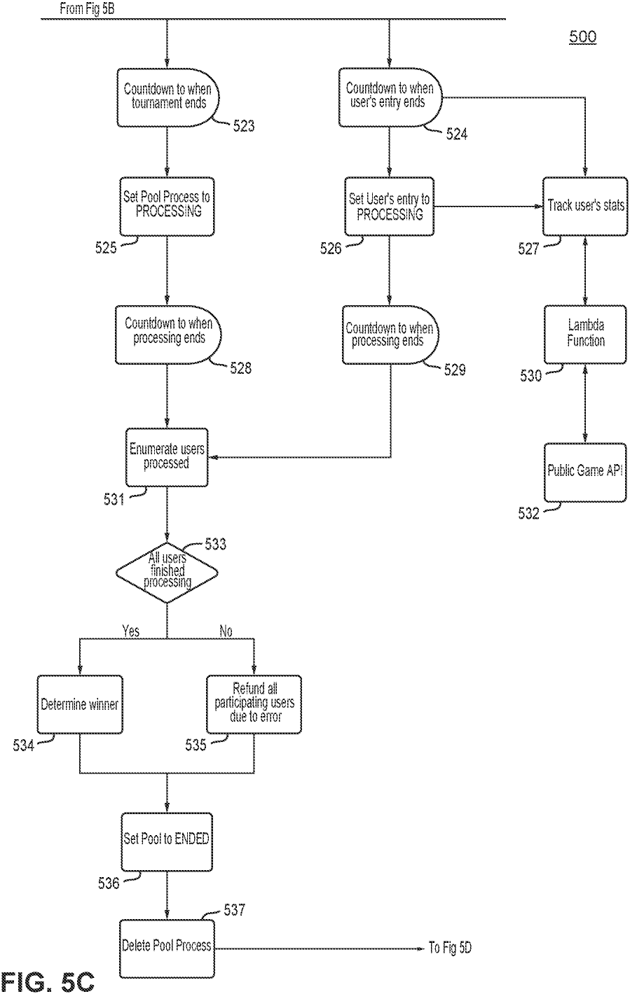

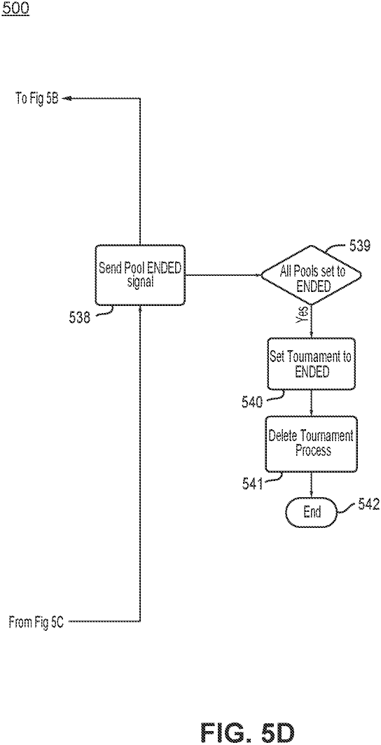

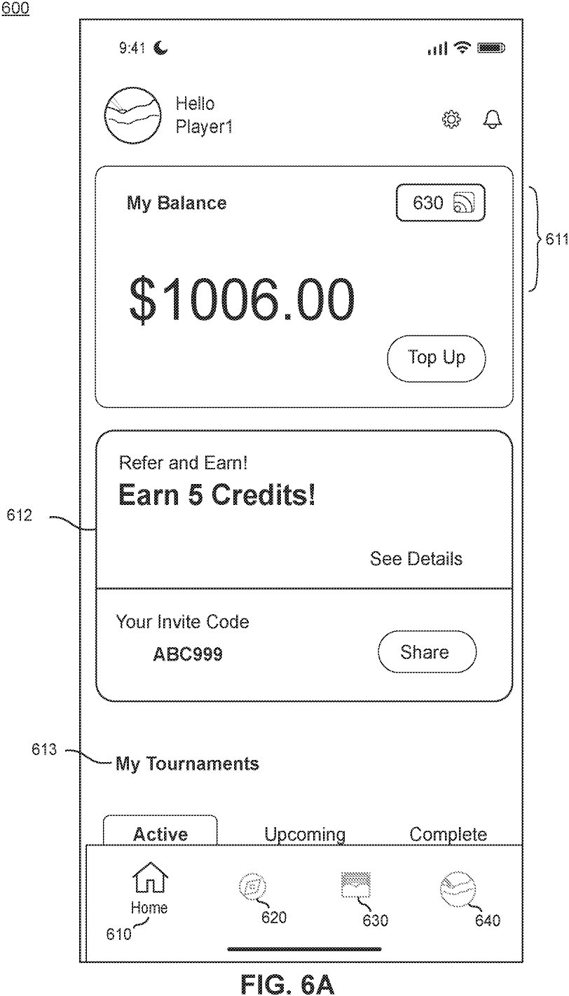

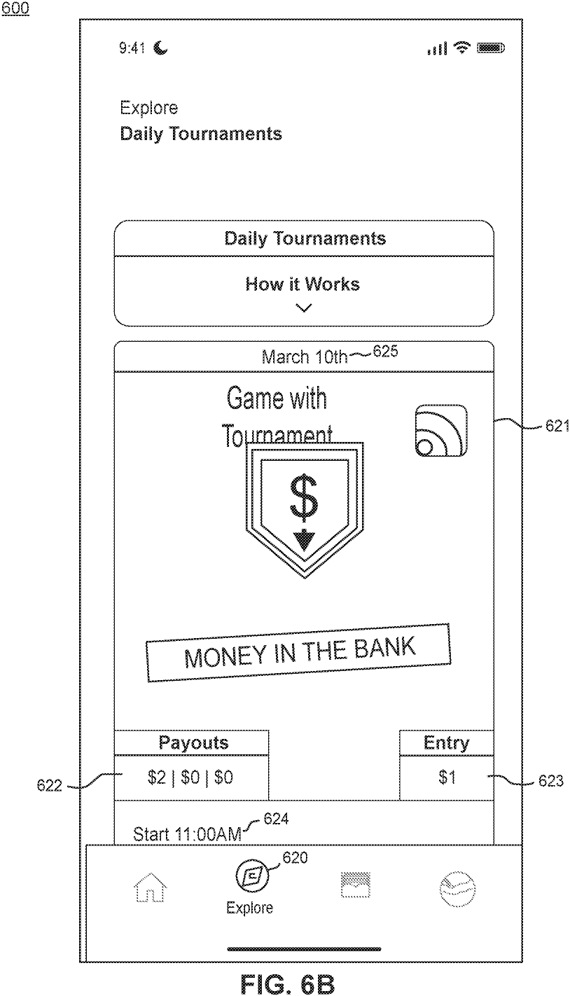

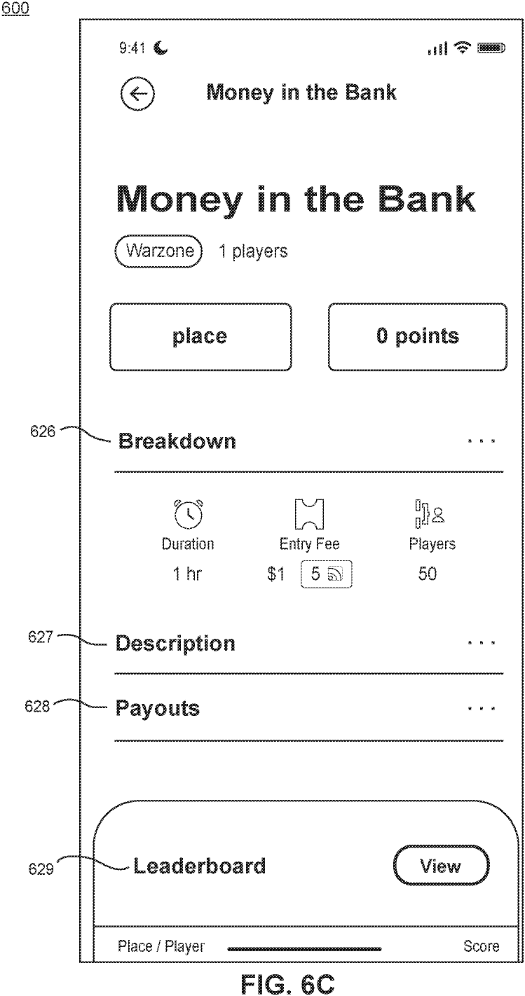

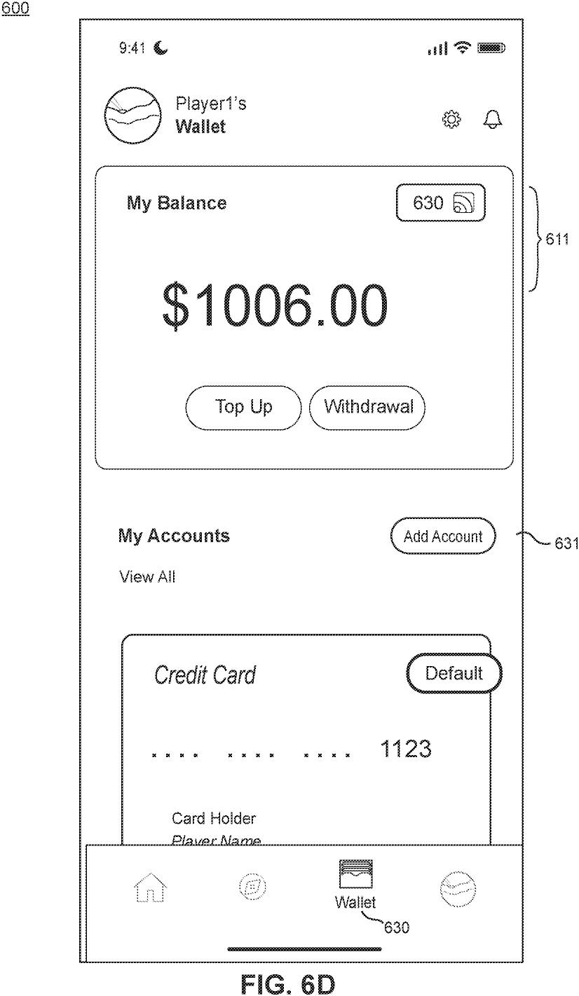

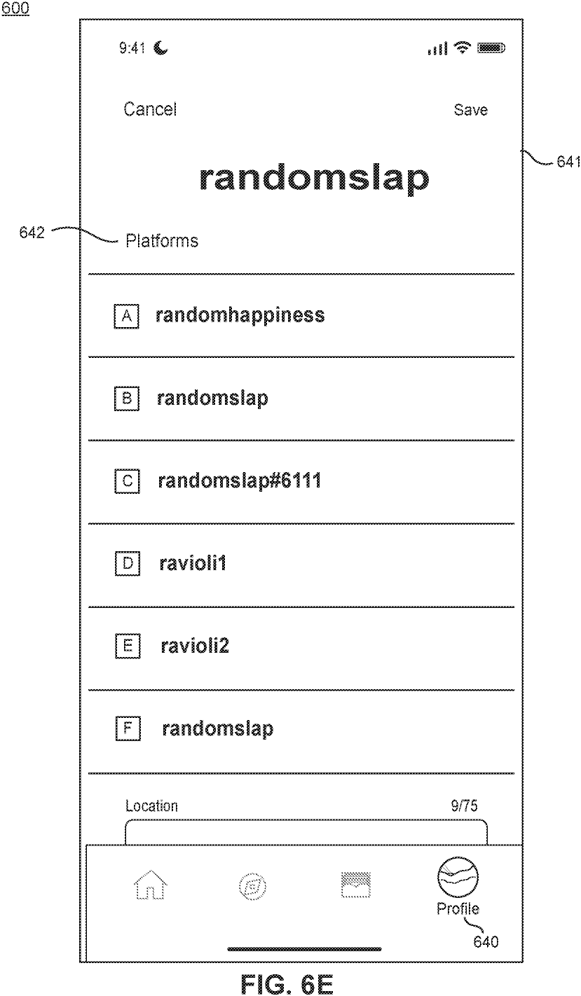

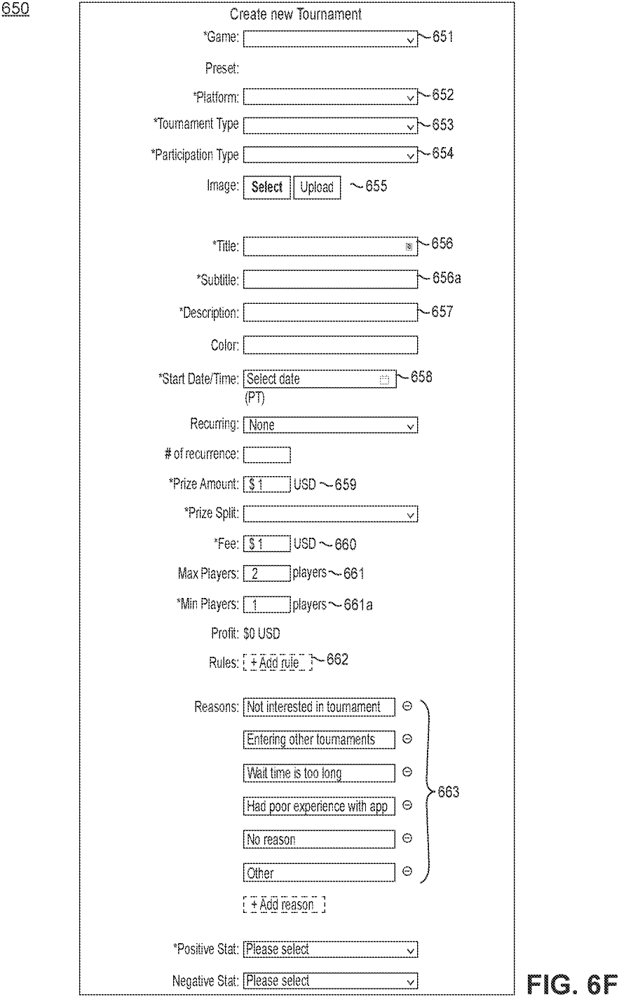

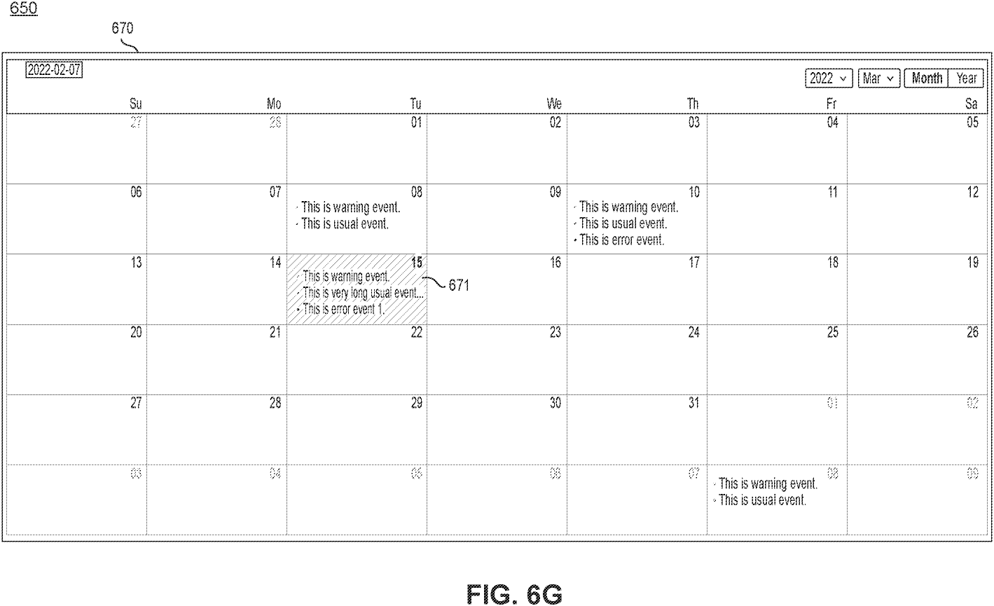

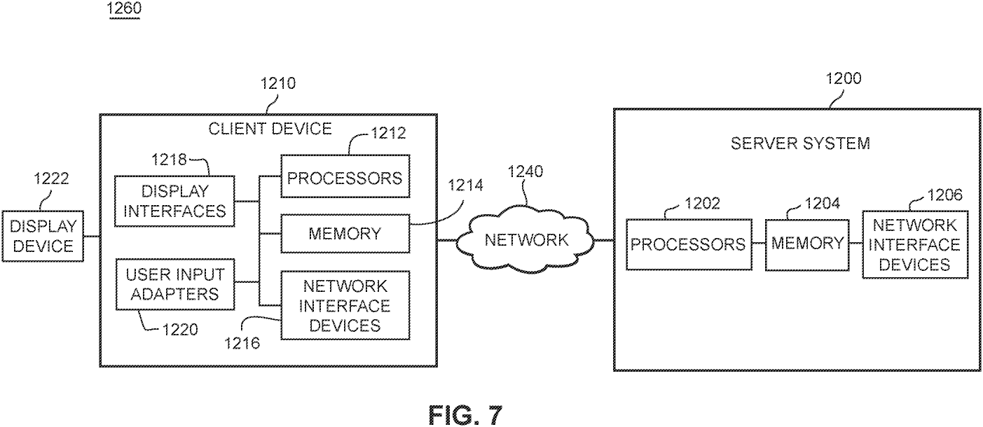

FIG. 1 depicts a non-limiting example block diagram of a system. FIG. 2 depicts a non-limiting example block diagram of software components included in the exemplary system, while FIG. 3 shows a non-limiting timing diagram of various components in a system. FIG. 4 shows a non-limiting example data structures, and FIGS. 5A-D show non-limiting example flowcharts depicting processes carried out in association with the system. FIGS. 6A-G show non-limiting example user interfaces associated with the system, and FIG. 7 shows a non-limiting example block diagram of hardware components comprising the system shown in FIG. 2, and throughout other portions of this document.

In many places in this document, software modules and actions performed by software modules are described. This is done for ease of description; it should be understood that, whenever it is described in this document that a software module performs any action, the action is in actuality performed by underlying hardware components (such as a processor and a memory) according to the instructions and data that comprise the software module.

FIG. 1 shows a non-limiting example diagram of a system 1 in which an environment for monitoring gameplay via an API is implemented. In one non-limiting example, system 1 includes various components that can communicate with each other (e.g., via a network). For example, system 1 may include client device(s) 100, game system(s) 50, monitoring system 200, API system 400, admin device(s) 300, and/or game server(s) 500. As a specific non-limiting example embodiment, game system(s) 50 could include one or more game consoles, portable game devices, and/or hybrid game systems. Client device(s) 100 can include any type of information processing system including, but not limited to, a personal computer, a smart device (e.g., smart phone), a tablet device, a personal digital assistant (PDA) device, and/or a game system discussed herein.

Game system(s) 50 may communicate with game server(s) 500 to conduct various gameplay associated with game system(s) 50. For example, game system(s) 50 may communicate with game server(s) 500 to participate in one or more on-line games, where game server(s) 500 can conduct matchmaking and on-line game processing associated with a game.

Client device(s) 100 may interact with monitoring system 200 to conduct processing associated with the game. For example, client device(s) 100 may be used to participate in a process (e.g., a tournament) associated with the game being played using game system(s) 50. In one non-limiting example, client device(s) 100 may execute an application program (e.g., a mobile application, a web-based application) to search for various tournaments for participating in a game, where a user may join a pool of the tournament using the application program running on client device(s) 100.

Monitoring system 200 may be configured to establish various tournaments (and associated pools in the tournament). In one example embodiment, an admin device(s) 300 can access monitoring system 200 to set up one or more tournaments associated with one or more video games. Client device(s) 100 may interact with monitoring system 200 to provide various information associated with gameplay occurring using game system(s) 50. Monitoring system 200 can communicate with API system(s) 400 to obtain various information associated with gameplay of system(s) 50 and server(S) 500.

In one example embodiment, API system(s) 400 may be configured to communicate with game server(s) 500 to obtain information associated with the gameplay of game system(s) 50. Monitoring system 200 may then use information returned from API system(s) 400 to measure play performance and conduct various scoring/ranking associated with the pools of each tournament. Monitoring system 200 may also employ various processing logic to create various pools in the tournament so that users may easily join gameplay. It should be appreciated that these examples are non-limiting and the technology described herein envisions any variety of mechanisms for carrying out processes associated with system 1.

It should also be appreciated that some of the components described in FIGS. 1-7 (and throughout any other portion of this document) may be referred to as singular or plural components. However, these descriptions are for illustration purposes and are non-limiting. For example, if a component is referred to as a system, it should be understand that the system could comprise a single component, or could be multiple components (included distributed components). Likewise, if a component is referred to as a plurality, it should be appreciated that the component may also be implemented via a single component as well.

FIG. 2 shows a non-limiting example diagram of a system 200 wherein the application architecture may be implemented. In particular, FIG. 2 depicts certain components shown in FIG. 1, where various software modules are further depicted. The example of FIG. 2 further depicts the admin device(s) 300, monitoring system 200, and API system(s) 400. FIG. 2 also includes cloud system 401 which can be optionally included in system 1. The elements shown in FIG. 2 include various software modules, and it should be appreciated that certain hardware elements associated with each client and/or server system, shown in FIG. 2, are depicted with respect to FIG. 7, discussed herein.

Admin device(s) 300 includes an admin interface module 310 configured to generate an application interface of an admin console. In one example embodiment, admin interface module 310 may generate a web-based interface, or could generate an application (e.g., mobile application) based interface. For example, admin interface module 310 of admin device(s) 300 could include a web browser application consisting of, at least, a rendering module, a networking module and a JavaScript module.

The rendering module can implement functionality for the graphical display and rendering of web page user interfaces. It can, for example, generate graphical data that corresponds to the HTML and/or DOM that defines a web page processed by the web browser application; this graphical data can, potentially after further modification/transformation by the operating system of the admin device(s) 300, be displayed on a display of the admin device(s) 300.

The networking module can implement the HTTP protocol, and be used to handle various HTTP messages between the admin device(s) 300 and the monitoring system 200. Alternatively or additionally, whenever it is described in this document that the admin device(s) 300 communicates using HTTP, the networking module may handle the HTTP aspects of such communications.

The JavaScript module can be used to execute JavaScript scripts, manipulate JavaScript objects, modify the DOMs of web pages loaded at the web browser application, and perform other functionality related to JavaScript. The JavaScript module may be, for example, a JavaScript engine, a JavaScript virtual machine, a JavaScript runtime, or any other type of software module capable of executing JavaScript instructions.

Admin interface module 310 thus allows admin device(s) 300 to display a user interface for configuring various aspects associated with monitoring system 200. In one example embodiment, admin device(s) 300 may display various components for creating a tournament where various parameters of the tournament may be set. Monitoring system 200 may then use these parameters (e.g., using monitoring logic module 230) to generate a tournament displayable via client device(s) 100, where users may understand the parameters associated with the tournament and decide whether to join the tournament. Certain example user interfaces associated with the admin device(s) 300 are shown with respect to FIGS. 6F-G, and discussed herein.

Monitoring system 200 may include software modules for monitoring various aspects of gameplay using the API technology described herein, as well as software modules for generating user interfaces that can be utilized by client device(s) 100. In one example embodiment, monitoring system 200 may include an API call module 210, data processing module 220, monitoring logic module 230, and/or a user interface module 240. As a non-limiting example, API call module 210 may execute one or more API calls to API system(s) 400. Alternatively, API call module 210 may interact with cloud system 401 to execute the various API calls made to API system(s) 400. API call module 210 may execute an API call requesting all aspects of data associated with a video game application to API system(s) 400. Likewise, API call module may execute one or more API calls requesting specific aspects of data associated with the video game application (e.g., using parameters set via admin device(s) 300).

System 1 may optionally employ cloud system 401 which could include a cloud service module 402. Cloud service module 402 may be responsible for accepting (and optionally processing) API calls made from monitoring system 200. In one example embodiment, cloud service module 402 may validate the API calls to determine if the call can be validly executed by API system(s) 400. Cloud service module 402 may also make/transfer calls made by monitoring system 200 to API system(s) 400 using a terminal network address (e.g., IP address). In one example embodiment, cloud service module 402 (or, alternatively, API call module 210 of monitoring system 200) may generate different network addresses on each call.

As discussed herein, API system 400 may impose certain restrictions on the nature of calls made to system 400. For example, API system 400 may set a limit on a number of requests made from a specific network address. This example is of course non-limiting and API system 400 may set any other types of restrictions associated with API calls made to system 400. For example, API system 400 may restrict a number of consecutive calls made to system 400 within a specified period of time (e.g., no consecutive calls within a 10 minute time window). By making calls using continuously changing network addresses, system 1 advantageously reduces (or eliminates) the number of restricted API calls made between monitoring system 200 and API system 400. In doing so, the number of unnecessary requests made in system 1 are substantially reduced thus reducing wasting processing resources of system 1, and improving overall communication between components.

API system(s) 400 may include an API call processing module 410 and API database module 420. API database module 420 may store various information associated with gameplay of one or more video game (or any other application). API database module 420 may include a database that manages the persistent storage of data that is used at the API database module 420. The database may be or include one or more of: a relational database management system (RDBMS); an object-oriented database management system (OODBMS); an object-relational database management system (ORDBMS); a not-only structured query language (NoSQL) data store; an object cache; a distributed file system; a data cluster (based on technology such as Hadoop); and/or any other appropriate type of data storage system.

API call processing module 410 may process the API calls made from monitoring system 200. In one example embodiment, API call processing module 410 may determine if a call is valid (e.g., if cloud system 401 is not employed). API call processing module 410 may process the one or more API calls made by system 200 to obtain various data from API database module 420. API call processing module 410 may then return the data to monitoring system 200. In one example embodiment, the data may be returned via one or more data objects (e.g., in a JSON file). Certain example embodiments of the returned data are depicted with respect to FIG. 4, described herein.

Monitoring system 200 may obtain the data returned from API system(s) 400 to process various elements and utilize the same in application processing. In one example embodiment, data processing module 220 may parse elements of data returned from API system(s) 400 and store the same in a database of system 200. For example, monitoring system 200 may receive a JSON file from API system(s) 400, where data processing module 220 may parse various elements of the JSON file (as shown, for example, in FIG. 4).

Monitoring logic module 230 may use the elements to conduct various processing associated with one or more applications (or video games). For example, monitoring logic module 230 may use the parsed elements to measure performance of one or more users in video game play to determine how well a user performs in a pool of a tournament. As discussed herein, monitoring logic module 230 may process such data in view of parameters set by admin device(s) 300 and such information may resultantly be used in determining how users performed in one or more pools of a tournament, as a non-limiting example. User interface module 240 can generate one or more user interface elements displayable by client device(s) 100. Various aspects associated with user interface module 240 are depicted with respect to FIGS. 6A-G, discussed in detail herein.

FIG. 3 shows a non-limiting example communication process between components of system 1. In the example shown in FIG. 3, client device(s) 100, monitoring system 200, and API system(s) 400 are depicted where various communication occurs between each component. The communication process may begin by client device(s) 100 initiating communication with monitoring system 200 for one or more users participating in a process (e.g., tournament) associated with monitoring system 200.

In the example of FIG. 3, client device(s) 100 may submit a request to join the process (at action 301) where the request may include certain information for joining the process. For example, a user may operate client device(s) 100 to view different tournaments for participating in an on-line game, where the user can select a specific tournament to join. One example tournament may be for a first person shooter game where users will compete for most kills in an hour in a “deathmatch” competition. The user may provide certain credentials, such as a gaming platform (e.g., Sony PlayStation®, Microsoft Xbox®) in which the user is playing and a user name associated with the gaming platform. These examples are of course non-limiting and the user can provide any variety of information including certain user profile information (e.g., user date-of-birth, user real name, user address).

Monitoring system 200 can accept information transmitted from client device(s) 100 and (at action 302) can validate the information and acknowledge the same to client device(s) 100. For example, monitoring system 200 may determine whether the user platform and user name are valid and send a respective acknowledgment back to client device(s) 100.

Once the information has been validated, monitoring system 200 (at action 303) can add the user to a sub-process of the selected process, and can execute the sub-process. As a non-limiting example, monitoring system 200 can add the user to a pool of a selected tournament where other users may also be added to a pool. Using the example from above, other users may join the tournament for obtaining most kills in an hour in the “deathmatch” competition, where monitoring system 200 can continually add users to a pool of the competition. In one example, after a certain number of users (e.g., 50 users) has entered a pool, system 200 may create another pool to add further users. This example is of course non-limiting and the technology described herein envisions any variety of mechanisms for placing a user in a particular pool.

Monitoring system 200 may make API calls (at action 304) using the information provided by client device(s) 100 as well as using any other parameters (e.g., set by admin device 300). In one example embodiment, system 200 may make one or more API calls requesting data associated with a group of user names, where certain parameters in the request may also be set. For example, system 200 may make one or more API calls that include each user name in a pool, as well as the game mode type, and any other qualifying factor.

API system(s) 400 may (at action 305) validate the API calls and/or return an acknowledgement of the same. For example, system(s) 400 may perform syntax checking against the API calls (among other checks) to ensure that the calls are being properly placed and can notify system 200 if the calls are correct or incorrect. If the calls are valid, API system(s) 400 can (at action 307) process and obtain data associated with the one or more API calls. In one example embodiment, API system(s) 400 may collect data for each of the API calls and return the same (at action 308) in a data file (or through any other mechanism of transmission). For example, API system(s) 400 can compile the obtained data in a JavaScript Object Notation (JSON) file and transmit the same to monitoring system(s) 200.

Monitoring system 200 may (at action 309) process the returned API call data and execute various monitoring logic. In one example embodiment, system 200 may parse the data received in the JSON file and compile various statistics associated with each user in a pool of a selected tournament. System 200 may monitor player performance using this data and then can assign scores and/or rank each user. System 200 may also provide certain users with an award (e.g., in game award, virtual currency, real currency) based on the user score and/or ranking.

Client device(s) 100 (at action 310) may make various requests for user interface data from monitoring system 200 to generate various user interface(s) on each client device(s) 100, and system 200 may respond (at action 311) with user interface data. In one example embodiment, the user interface of client device(s) 100 may show various information related to player performance in each pool, the system 200 can update the user interface data to provide the user with such information. These examples are of course non-limiting and the technology described herein envisions and variety of user interface data transmittable between device(s) 100 and system 200.

It should be appreciated that certain elements not shown in FIG. 3 (but shown in other places) are merely for illustration purposes. For example, optional cloud system 401 could be provided (e.g., between monitoring system 200 and API system(s) 400). Moreover, it should be understood that, although action 301 through action 311 are described above as separate actions with a given order, this is done for ease of description. It should be understood that, in various embodiments, the above-mentioned actions may be performed in various orders; alternatively or additionally, portions of the above-described actions (action 301 through action 311) may be interleaved and/or performed concurrently with portions of the other actions (action 301 through action 311).

FIG. 4 shows a non-limiting example data file 400 including elements/objects associated with application monitoring. In the example shown in FIG. 4, the data objects are contained within a JSON file where the JSON file may include a plurality of different objects associated with one or more user profiles for one or more application (e.g., video game applications). The system 1 is capable of parsing the elements in the data file 400 to extract and process data associated with application monitoring for one or more applications. The elements extracted from data file 400 can be used to measure user participating in one or more games as described herein, as a non-limiting example.

Data file 400 includes various objects where each object may contain further detailed elements. For example, data file 400 includes a “tag” labeled “data” where different elements are contained (sometimes within a “hierarchy”). In more detail, certain “base” level elements within “data” include a title field 401 where a title or name of an application might be depicted. In the example shown in FIG. 4, title field 401 includes “mw” which could correspond to Call of Duty: Modern Warfare®. A platform field 402 is also included which could indicating a platform in which the application is being executed. For example, platform field 402 could identify a specific gaming console platform, or could identify a particular gaming service available in personal computers (PC).

Data file 400 may also include username field 403 which could identify a specific username of a player. As discussed herein, the username and platform (taken from username field 403 and platform field 402, respectively) can be used to obtain the game performance data shown within data file 400 (and processed by monitoring system 200).

Data file 400 may contain other various information used for monitoring user progress in one or more applications. In the example of FIG. 4, data file 400 can further include overview elements 404 providing a plurality of different overview items. The overview elements 404 can include a player type field indicating a specific type of a player in a game and a level field indicating a current “experience” level of the player in the game. Overview elements 404 can include other various overview information of the user including, but not limited to, prestige level, game rankings, and experience points/levels, among other elements.

Data file 400 can further include user detail elements 405-407. In the example shown in FIG. 4, detail elements 405-407 include certain detail items associated with a user in a particular game. For example, detail elements 405 include various elements associated with user properties across various game modes. Detail elements 405 can include items such as user accuracy (e.g., in a first person shooter game), win/loss ratio, and a best score (among other elements).

Detail elements 406 and 407 can include detail items associated with the user in specific game modes. For example, detail elements 406 could include items associated with a user in a “gun game” mode where items such as user score, kill number, stab number, and/or kill-to-death ratio can be included (among other elements). Detail elements 407 could include items associated with a user in a “domination” game mode where items can also include user score, kill number, stab number, and/or kill-to-death ratio can be included (among other elements). These examples are non-limiting and the data file 400 can include a plurality of various data associated with one or more users using an application program.

FIGS. 5A-D show non-limiting example flowcharts associated with system 1. In particular, FIGS. 5A-D show an example tournament creation process 500 for generating a tournament and associated pools. It should be appreciated that FIGS. 5A-D show various elements that may flow into each other, where further descriptions of the process are depicted in the continuing figures. The process begins in FIG. 5A (at action 501) where a tournament process can be invoked. In one example embodiment, tournament information can be sent to a server endpoint where the engine application is running. The engine application forwards and submits the tournament info as an item to the database. The system 1 creates a new tournament process application with the tournament information. The tournament process name can be labeled with a “t-” along with the tournament identifier (ID) (e.g., “t-a9aa318c-8d39-4dcd-abec-7d4cb5e35c3e”).

Upon invoking the process, system 1 can perform an authenticate middleware routine (at action 502) in order to authenticate the component that desires to initiate one or more API calls. If the authenticate middleware process fails, a “status 400” response is returned (at action 503) where the response may indicate that the authentication did not succeed. If the authenticate middleware process succeeds, system 1 may (at action 504) invoke a router function. In one non-limiting example, the router function may include a route handling routine for performing various API calls. After the router function has been invoked, system 1 may (at actions 505 and 506) initiate a “/create” process for creating the tournament process, and also invoke a tournament controller for creating and managing the tournament process.

FIG. 5B shows a non-limiting example process associated with operation of the tournament controller. The process continues (at action 507) where the tournament controller is started, and the create tournament process is initiated (at action 508) resulting in the created tournament process (at action 509). When a tournament is created, the tournament may not contain any users initially and thus the tournament process is set to a standby state (at action 510).

As users join the tournament, system 1 can (at action 511) create a pool process where one or more pools of the tournament are initiated and generated (at action 515). More specifically, the tournament process can create a pool item in the database, and the pool condition is set to “STANDBY” (at action 514) (e.g., as one or more users begin join the pool). After setting the pool process to a standby state, the system 1 can determine (at action 516) if a tournament has already started (e.g., the starting time for beginning a tournament has passed). If the tournament has not yet started, system 1 will (at action 518) operate a timer to countdown when a tournament may begin. In particular, and based on the information submitted from the CMS, the tournament process will count down to when the tournament starts. As a non-limiting example, the tournament may be set to begin at 12 PM EST on a given day and, if the current time is 11 PM EST, the countdown may indicate 60 minutes currently remain until the tournament starts.

After the countdown reaches zero, system 1 can set the tournament and pool to a started state (at action 519) where the system 1 will listen for user entries (at action 521). In one example embodiment, system 1 may add a user (at action 522) as users enter a given pool. It should be appreciated that a given pool may have a maximum size (e.g., 50 participants). In such cases, as a user enters a given pool, system 1 may determine if the maximum number of participants for the pool has been reached (at action 517). If the maximum number has been reached, system 1 may keep a pool set to a started state (at action 512) where another pool process is created (at action 511). The various steps for creating a pool process are then carried out again until a maximum number of users has been reached for the new pool.

As system 1 listens for users (at action 521), system 1 may also detect whether any parameters for the tournament are recurring (at action 520). In more detail, once the countdown has reached 0, the tournament process will check if the tournament data has a recurring parameter. Specifically, if there is a recurring parameter, the process will submit a new tournament to the database with the same information but with a different start time and tournament ID. The process will create a new process for the tournament to recur, and the start time is formed from the tournament recurring parameters submitted by the system (at action 513). The tournament process establishes a new pool process for the pool item that was generated, and the tournament process will listen to any internal signals that are sent to it.

Similar processes may be carried out for each pool process (e.g., shown at action 511). In more detail, the pool process name can be designated with a “p-” along with the pool ID (e.g., “p-cd785a31-ff83-4881-95dc-f9d2f4d93ed7”). The pool process will update the condition in the pool’s item as “STARTED,” and the pool process establishes a subscription/webhook to listen to user entry items in the database. Users can use a mobile application to create an entry item in the database, and the entry ID contains the user’s game ID in order to retrieve their data from the game’s public API. The subscription/webhook for joining users can perform various tasks as well. In particular, the subscription/webhook can check if the entry’s tournament ID matches with the pool process’s tournament ID to ensure the user is joining the right tournament, and can check if the pool has the “STARTED” condition and has reached the max player threshold according to the tournament’s parameters. If the threshold is reached, the pool process will create a new pool process and pool item in the database. After the checks are complete, the user’s entry item will be sent to the stat-tracking logic. A countdown can also begin in order to determine when the tournament will end, and the pool process will listen to any internal signals that are sent to it.

FIG. 5C thus shows a non-limiting example of further processes associated with the tournament creation process 500. In more detail, FIG. 5C depicts certain actions associated with listening for user entries (action 521) and adding user entries (action 522). Continuing from FIG. 5B, as system 1 listens for user entries, system 1 can operate a countdown to when the tournament ends (at action 523). Similar to the countdown for starting a tournament, the countdown for when the tournament ends may count from the current time to when the tournament is expected to end. For example, if the current time is 4 PM EST and the tournament is ending at 5 PM EST, the countdown timer may indicate 60 minutes remaining in the tournament.

If the pool is continuing, system 1 may set the pool to a processing status (at action 525) where another countdown timer is operated for counting down to when processing ends (at action 528). As user entry processing occurs (at action 522), system 1 may operate a countdown timer counting down when user entry ends (at action 524). As the user entry processing continues, system 1 may set user entry status to processing (at action 526) where user statistics may be tracked (at action 527) using the various API calls (also referred to as “stat track logic”).

In more detail, in stat track logic processing, each user’s entry will be processed within the pool process and will not be in an own process. The stat-tracking will check the user’s game stats by using the game’s public API, and will set the existing stats as the initial stats. A countdown will begin in order to keep track of how long the user is allowed to play, where the time length may be based on the tournament’s parameters. The user’s stats will then be checked via the game’s public API in intervals to examine if the stats have increased. If the new retrieved stats are greater than the initial stats, the score in the user’s entry item will be updated with the difference between the new stats and the initial stats, where user can be notified (e.g., via push notification) that their score has updated.

When the countdown has reached 0, the condition of the user’s entry will be set as “PROCESSING,” and the user can be notified (e.g., via push notification) that their entry is being processed and finalized. Further stat-tracking checks can be performed within the “PROCESSING” period. The “PROCESSING” period can vary depending upon the game, and the period can be tracked by a countdown and will be over when it reaches 0. Once the “PROCESSING” period is over, the stat-tracking will send an internal signal, “ST_ENDED” to the pool process to notify that the user’s entry has finished, and the pool process can keep track of how many user entries have been completed.

In one non-limiting example embodiment, system 1 may (at action 530) invoke a Lambda function (e.g., an AWS Lambda® function) initiating a compute service that lets you run code without provisioning or managing servers. In one example embodiment, the Lambda function may allow a virtual terminal to make API request (at action 532) to a public game API. The Lambda function may operate as an event-driven, server-less computing platform that allows the system 1 to make various API calls seemingly coming from various different terminals with different network addresses. In doing so, system 1 can make numerous API calls without reaching any threshold maximum number of API calls thus reducing the number of unnecessary API calls made to the public game API. By reducing the number of unnecessary API calls made to the public game API, system 1 advantageously conserves processing resources and improves the overall communication process within system 1.

As user entry processing occurs, system 1 may (at action 529) operate a countdown timer counting down to when processing ends (i.e., similar to action 528). As processing for a tournament/pool ends, system 1 can (at action 531) enumerate the users that are processed. In one example embodiment, system 1 can identify users by providing a number to each, and can also accumulate the number of users in a given process. System 1 may determine (at action 533) is all users have finished processing and if not, system 1 may (at action 535) refund all participating users (e.g., due to error).

If all users have finished processing, system 1 may determine a winner among the users in a given pool (at action 534) (also referred to as “winner logic”). In one example embodiment, system 1 may tabulate user score and award a user as winner based on a highest score. In more detail, once the pool process’s countdown reaches 0, all of the user entries will be sent to the winner logic. Each user’s entry will be processed within the pool process and will not be in an own process. The winner logic will put all the user entries in order based off of the scores, will add funds to the user’s wallet if certain conditions are met. The user’s entry is set to “ENDED,” and the winner logic will send an internal signal, “ENDED” to the pool process (at action 536) that the winner has been determined. System 1 may then delete the specified pool process (at action 537). These examples are of course non-limiting and the technology described herein envisions any variety of methods for awarding one or more users.

FIG. 5D shows a non-limiting example of further processes associated with the tournament creation process 500. The example shown in FIG. 5D depicts various processes that occur after a pool process is deleted (at action 537) to the tournament creation process (at action 509). In the example shown in FIG. 5D, system 1 may send (at action 538) a pool ended signal where system 1 may determine (at action 539) if all pools are set to an ended status. If there are one or more pools still active, system may repeat the tournament/pool processing by returning to tournament process (at action 509).

If all pools are set to the ended status, system 1 may set the tournament to an ended status (at action 540) (also referred to as “clean-up” logic). In more detail, when the pool process retrieves all of the user’s entry “ENDED” signals, the pool process will then set the condition of the pool’s item as “ENDED.” The pool process will send an internal signal, “ENDED” to the tournament process, and the pool process will terminate itself after the signal is sent. Once the tournament process retrieves the “ENDED” signal from every pool process, the tournament process will set the condition of the tournament item to “ENDED.” The tournament process can terminate itself after it has updated the tournament item (at action 541) where processing will be completed (at action 542). Although action 501-542 are shown in FIGS. 5A-D as occurring once, these actions 501-542 may, in various embodiments, be repeated a number of times during the creation and management of different tournaments and/or pools.

FIGS. 6A-G show non-limiting example user interfaces 600 and 650 generated by system 1. In one non-limiting example, user interfaces 600 and 650 can be transmitted as data packets to one or more client devices (e.g., client device(s) 100) and/or one or more admin systems (e.g., admin device(s) 300). It should be appreciated that the user interfaces can be generated and displayed using a variety of application types. For example, user interfaces 600 and/or 650 may be generated and displayed as a web-based application. Alternatively, user interfaces 600 and/or 650 may be generated and displayed as a mobile application (e.g., smartphone application, tablet application). These examples are of course non-limiting and the technology described herein envisions any variety of mechanisms for generating and displaying user interfaces 600 and 650.

FIGS. 6A-E show non-limiting example user interface 600 for generating and displaying different views associated with system 1. In one non-limiting example embodiment, user interface 600 may be a user interface for a mobile application where different elements and views can be navigated (e.g., by input to a touch sensitive display). Of course, this example is non-limiting and user interface 600 may be generated and displayed via any other means (e.g., as a web-based application).

User interface 600 includes certain navigable elements allowing a user to navigate through various views. For example, user interface 600 include home view 610 (e.g., for generating and displaying a home page/view), explore view 620 (e.g., for generating and displaying an explore page/view), wallet view 630 (e.g., for generating and displaying a funds page/view), and/or profile view 640 (e.g., for generating and displaying a profile page view).

In the example shown in FIG. 6A, home view 610 is selected and emphasized in user interface 600, where the corresponding display includes the home page/view (“page/view” is hereinafter referred to as just “view”). The home view includes certain summary level information as well as other general information associated with the user. In one example embodiment, the home view could include a balance indicator 611 indicating a monetary balance associated with the user. The balance could be applied to entering and participating in various tournaments associated with one or more games.

The home view can also include a notification item 612 that can notify the user of various aspects associated with the system 1. In the example shown in FIG. 6A, notification item 612 includes a brief notification to the user regarding the ability to earn credits within system 1 by referring other users to the system 1. The home view can also include tournaments indicator 613 showing active, upcoming, and/or completed tournaments. In one non-limiting example, a user may provide input to an area associated with the text “active,” upcoming,” and/or “complete” in order to generate data for display associated with active, upcoming, and/or completed tournaments.

FIG. 6B shows another non-limiting example user interface 600 where the explore view is generated and displayed (with explore view 620 being selected and emphasized). In one example embodiment, the explore view can show certain information for exploring different elements associated with system 1. For example, the explore view could allow a user to “explore” which tournaments are available to join/participate.

In the example shown in FIG. 6B, the explore view includes tournament element 621 displaying certain information associated with a particular tournament. In the example shown in FIG. 6B, tournament element 621 is for a “Money in the Bank” tournament where certain information associated with playing the tournament can be displayed (e.g., by selecting the “How it Works” tab).

Tournament element 621 includes various information for the rules and/or parameters associated with the tournament. For example, tournament element 621 includes a start time element 624 and a date element 625 indicating a starting date and time for participating in the tournament. Tournament element 621 further includes a payout element 622 indicating a payout value associated with player performance. In the example shown in FIG. 6B, payout element 622 includes three fields (e.g., showing payout for first, second, and third, respectively), where different values can be populated in each field. This example is of course non-limiting and the technology described herein envisions and variety of methods for depicting payout in payout element 622.

Tournament element 621 also include entry element 623 indicating an entry amount for participating in the tournament. In the example shown in FIG. 6B, entry element 623 is $1 USD. It should be appreciated that the monetary values reflected herein are for illustrative purposes only and any monetary (or non-monetary) value can be used. It should be further appreciated that the explore view depicts a single tournament element 621 in FIG. 6B. But, this example is of course non-limiting and the system envisions depicting multiple tournament elements and/or other information. For example, other various tournament elements may be displayed as the user scrolls up/down in the explore view.

In more detail, FIG. 6C shows another non-limiting example user interface 600 where other elements of the explore view are depicted. In the example shown in FIG. 6C, user interface 600 includes further detailed elements associated with tournament element 621 shown in FIG. 6B. In more detail, user interface 600 includes a breakdown element 626, description element 627, payouts element 628, and leaderboard element 629. It should be appreciated that these additional elements may be viewed as the user scrolls through the user interface 600 and/or selects various items displayed on interface 600.

Breakdown element 626 may include certain summary information associated with the tournament depicted by tournament element 621. For example, breakdown element 626 may include a duration of the tournament (e.g., one hour), an entry fee for participating in the tournament (e.g., $1), and/or a number of players in the tournament (or a number of maximum players in a pool of the tournament) (e.g., 50 players).

Description element 627 can include a description associated with tournament element 621. For example, description element 627 could include text (and/or image) data describing various aspects of the tournament as well as any rules/parameters associated with the tournament. In similar fashion, payouts element 628 could provide further detailed information of the associated payout for participation. For example, payouts element 628 could expand to show a listing of payouts based on where a user ranks after completing participation in a tournament. Leaderboard element 629 could be expanded in interface 600 to show a current listing of participants and associated ranks of each participant. For example, when leaderboard element 629 is selected, the display may be expanded to show a numerical ranking of each user where other elements (e.g., user name, score) are displayed in association with the user.

FIG. 6D shows another non-limiting example user interface 600 where the wallet view is generated and displayed (with wallet view 630 being selected and emphasized). In the example shown in FIG. 6D, certain information associated with user account balance and various payment methods may be generated and displayed. In more detail, the wallet view can include the balance indicator 611 indicating a monetary balance associated with the user (e.g., as shown in FIG. 6A).

Balance indicator 611 may include certain selectable options (e.g., “top up,” “withdraw”) where the options allow the user to perform actions associated with the balance. For example, selecting a “withdraw” option allows the user to withdraw funds from the account. The wallet view may further include payment accounts element 631 where one or more payment accounts may be associated. For example, the user may associate certain payment accounts (e.g., credit card, savings account, checking account, digital currency account) where payments can be processed by system 1. In the example shown in FIG. 6D, payment accounts element 631 shows an example credit card account, where the credit card is selected as the “default” payment method. Other payment accounts may be viewable/modifiable by manipulating user interface 600 (e.g., by scrolling left/right over payment accounts element 631).

FIG. 6E shows another non-limiting example user interface 600 where the profile view is generated and displayed (with profile view 640 being selected and emphasized). In the example shown in FIG. 6E, various aspects with a user profile may be generated and displayed. The profile view can include a user name 641 and a platform element 642. The user name 641 may include a user name associated with system 1. In one example embodiment, user name 641 may be the same, or different from), one or more user names depicted in platform element 642.

Platform element 642 may include one or more system platforms for executing an application (e.g., video game). In the example shown in FIG. 6E, an icon associated with each platform in platform element 642 is shown, where a user name is displayed next to a corresponding icon. In one example embodiment, the user name shown next to each icon may reflect the user name of the user for that platform. The profile view may show various platforms associated with a user and may also provide the user with input options for adding/modifying/deleting various platforms associated with a user profile. For example, the user may select an “add platform” button to generate a display to provide certain credential information (e.g., user name and password) associated with a particular platform. These examples are of course non-limiting and the technology described herein envisions any variety of information that can be displayed in the various views of user interface 600.

FIGS. 6F and 6G show non-limiting example user interface 650 associated with different admin user interfaces and views. In the example shown in FIGS. 6F and 6G, the user interface 650 may be generated and displayed as a web-based application. Of course, this example is non-limiting and user interface 650 may be generated and displayed via any other means (e.g., as a mobile application).

User interface includes an input view where different input elements (e.g., elements 651-663) may be used to obtain input for creating a tournament. The input view includes a game input element 651 where a specific application/game can be selected. For example, game input element 651 may allow an admin user to select a specific first person shooter video game from a listing of video games.

The input view further includes a platform input element 652 where a specific platform may be selected. For example, platform input element 652 may include a drop-down list of different platforms (e.g., video game console, PC) associated with a selected game. Tournament type input element 653 may be further included in the input view where different types of tournaments are selectable. For example, tournament type input element 653 could include different game modes associated with a selected game (e.g., death match game mode of a first person shooter game).

The input view may further include a participation type input element 654 where different user participation types may be input. The input view may further include an image input element 655 where one or more images may be associated with the tournament (e.g., and displayed via user interface 600). The input view may also include title input element 656 and subtitle input element 656a where a title (and subtitle) for the tournament may be input.

The input view further includes a description input element 657 where a detailed description of the tournament may be input. The input view can further include a start date/time input element 658 for selecting a starting date and time for the tournament. For example, the user may select a date (e.g., from a displayed calendar) where a specific time (in a specific time zone) may be selected. The input view includes other elements (not labeled) for user input. For example, the user can select a recurrence type of the tournament (as well as a number of times it should recur).

The input view can also include a prize input element 659 where a prize amount may be input. The prize amount can be in the form of a real currency, a digital currency, and/or a virtual currency. The input view may also include a fee input element 660 where a fee for joining the tournament may be input. The input view can also include a max player input element 661 and min player input element 661a where maximum and minimum players for the tournament may be respectively set.

The input view may also include a rule input element 662 where one or more rules for participating in the tournament may be selected. For example, rule input element 662 may include certain game rules that must be followed where violation of the rules may incur certain penalties. The input view may also include a reasons field input element 663 where different reasons may be generated in association with user experience. For example, reasons field input element 663 may include one or more reasons (e.g., in a survey) as to why a user did not participate in a particular tournament. These examples are of course non-limiting and the technology described herein envisions any variety of input elements for the input view.

FIG. 6G shows another non-limiting example user interface 650 associated with the admin interface. In the example of FIG. 6G, a calendar item 670 is included where different calendar elements 671 are displayed. The calendar item 670 may include different calendar views (e.g., daily, weekly, monthly, yearly) where different elements are displayed in the views. Calendar elements 671 may include certain information associated with different tournament events. The calendar item 670 and calendar elements 671 may inform an admin user of different events occurring on various selected days.

FIG. 7 shows a non-limiting example block diagram of a hardware architecture for the system 1200. In the example shown in FIG. 7, the client device 1210 communicates with a server system 1250 via a network 1240. The network 1240 could comprise a network of interconnected computing devices, such as the internet. The network 1240 could also comprise a local area network (LAN) or could comprise a peer-to-peer connection between the client device 1210 and the server system 1250. As will be described below, the hardware elements shown in FIG. 7 could be used to implement the various software components and actions shown and described above as being included in and/or executed at the client device 1210 and server system 1250.

In some embodiments, the client device 1210 (which may also be referred to as “client system” herein) includes one or more of the following: one or more processors 1212; one or more memory devices 1214; one or more network interface devices 1216; one or more display interfaces 1218; and one or more user input adapters 1220. Additionally, in some embodiments, the client device 1210 is connected to or includes a display device 1230. As will explained below, these elements (e.g., the processors 1212, memory devices 1214, network interface devices 1216, display interfaces 1218, user input adapters 1220, display device 1230) are hardware devices (for example, electronic circuits or combinations of circuits) that are configured to perform various different functions for the computing device 1210.

In some embodiments, each or any of the processors 1212 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1212 uses an instruction set architecture such as x86 or Advanced RISC Machine (ARM).

In some embodiments, each or any of the memory devices 1214 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1212). Memory devices 1214 are examples of non-volatile computer-readable storage media.

In some embodiments, each or any of the network interface devices 1216 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces 1218 is or includes one or more circuits that receive data from the processors 1212, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 1230, which displays the image data. Alternatively or additionally, in some embodiments, each or any of the display interfaces 1218 is or includes, for example, a video card, video adapter, or graphics processing unit (GPU).

In some embodiments, each or any of the user input adapters 1220 is or includes one or more circuits that receive and process user input data from one or more user input devices (not shown in FIG. 8) that are included in, attached to, or otherwise in communication with the client device 1210, and that output data based on the received input data to the processors 1212. Alternatively or additionally, in some embodiments each or any of the user input adapters 1220 is or includes, for example, a PS/2 interface, a USB interface, a touchscreen controller, or the like; and/or the user input adapters 1220 facilitates input from user input devices (not shown in FIG. 7) such as, for example, a keyboard, mouse, trackpad, touchscreen, etc...

In some embodiments, the display device 1230 may be a Liquid Crystal Display (LCD) display, Light Emitting Diode (LED) display, or other type of display device. In embodiments where the display device 1230 is a component of the client device 1210 (e.g., the computing device and the display device are included in a unified housing), the display device 1230 may be a touchscreen display or non-touchscreen display. In embodiments where the display device 1230 is connected to the client device 1210 (e.g., is external to the client device 1210 and communicates with the client device 1210 via a wire and/or via wireless communication technology), the display device 1230 is, for example, an external monitor, projector, television, display screen, etc...

In various embodiments, the client device 1210 includes one, or two, or three, four, or more of each or any of the above-mentioned elements (e.g., the processors 1212, memory devices 1214, network interface devices 1216, display interfaces 1218, and user input adapters 1220). Alternatively or additionally, in some embodiments, the client device 1210 includes one or more of: a processing system that includes the processors 1212; a memory or storage system that includes the memory devices 1214; and a network interface system that includes the network interface devices 1216.

The client device 1210 may be arranged, in various embodiments, in many different ways. As just one example, the client device 1210 may be arranged such that the processors 1212 include: a multi (or single)-core processor; a first network interface device (which implements, for example, WiFi, Bluetooth, NFC, etc...); a second network interface device that implements one or more cellular communication technologies (e.g., 3G, 4G LTE, CDMA, etc...); memory or storage devices (e.g., RAM, flash memory, or a hard disk). The processor, the first network interface device, the second network interface device, and the memory devices may be integrated as part of the same SOC (e.g., one integrated circuit chip). As another example, the client device 1210 may be arranged such that: the processors 1212 include two, three, four, five, or more multi-core processors; the network interface devices 1216 include a first network interface device that implements Ethernet and a second network interface device that implements WiFi and/or Bluetooth; and the memory devices 1214 include a RAM and a flash memory or hard disk.

Server system 1250 also comprises various hardware components used to implement the software elements for a server system. In some embodiments, the server system 1250 (which may also be referred to as “server device” herein) includes one or more of the following: one or more processors 1252; one or more memory devices 1254; and one or more network interface devices 1256. As will explained below, these elements (e.g., the processors 1252, memory devices 1254, network interface devices 1256) are hardware devices (for example, electronic circuits or combinations of circuits) that are configured to perform various different functions for the server system 1250.

In some embodiments, each or any of the processors 1252 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1252 uses an instruction set architecture such as x86 or Advanced RISC Machine (ARM).

In some embodiments, each or any of the memory devices 1254 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1252). Memory devices 1254 are examples of non-volatile computer-readable storage media.

In some embodiments, each or any of the network interface devices 1256 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In various embodiments, the server system 1250 includes one, or two, or three, four, or more of each or any of the above-mentioned elements (e.g., the processors 1252, memory devices 1254, network interface devices 1256). Alternatively or additionally, in some embodiments, the server system 1250 includes one or more of: a processing system that includes the processors 1252; a memory or storage system that includes the memory devices 1254; and a network interface system that includes the network interface devices 1256.

The server system 1250 may be arranged, in various embodiments, in many different ways. As just one example, the server system 1250 may be arranged such that the processors 1252 include: a multi (or single)-core processor; a first network interface device (which implements, for example, WiFi, Bluetooth, NFC, etc...); a second network interface device that implements one or more cellular communication technologies (e.g., 3G, 4G LTE, CDMA, etc...); memory or storage devices (e.g., RAM, flash memory, or a hard disk). The processor, the first network interface device, the second network interface device, and the memory devices may be integrated as part of the same SOC (e.g., one integrated circuit chip). As another example, the server system 1250 may be arranged such that: the processors 1252 include two, three, four, five, or more multi-core processors; the network interface devices 1256 include a first network interface device that implements Ethernet and a second network interface device that implements WiFi and/or Bluetooth; and the memory devices 1254 include a RAM and a flash memory or hard disk.

As previously noted, whenever it is described in this document that a software module or software process performs any action, the action is in actuality performed by underlying hardware elements according to the instructions that comprise the software module. Consistent with the foregoing, in various embodiments, each or any combination of the client device 210 or the server system 220, each of which will be referred to individually for clarity as a “component” for the remainder of this paragraph, are implemented using an example of the client device 1210 or the server system 1250 of FIG. 7. In such embodiments, the following applies for each component: (a) the elements of the client device 1210 shown in FIG. 7 (i.e., the one or more processors 1212, one or more memory devices 1214, one or more network interface devices 1216, one or more display interfaces 1218, and one or more user input adapters 1220) and the elements of the server system 1250 (i.e., the one or more processors 1252, one or more memory devices 1254, one or more network interface devices 1256), or appropriate combinations or subsets of the foregoing, are configured to, adapted to, and/or programmed to implement each or any combination of the actions, activities, or features described herein as performed by the component and/or by any software modules described herein as included within the component; (b) alternatively or additionally, to the extent it is described herein that one or more software modules exist within the component, in some embodiments, such software modules (as well as any data described herein as handled and/or used by the software modules) are stored in the respective memory devices (e.g., in various embodiments, in a volatile memory device such as a RAM or an instruction register and/or in a non-volatile memory device such as a flash memory or hard disk) and all actions described herein as performed by the software modules are performed by the respective processors in conjunction with, as appropriate, the other elements in and/or connected to the client device 1210 or server system 1250; (c) alternatively or additionally, to the extent it is described herein that the component processes and/or otherwise handles data, in some embodiments, such data is stored in the respective memory devices (e.g., in some embodiments, in a volatile memory device such as a RAM and/or in a non-volatile memory device such as a flash memory or hard disk) and/or is processed/handled by the respective processors in conjunction, as appropriate, the other elements in and/or connected to the client device 1210 or server system 1250; (d) alternatively or additionally, in some embodiments, the respective memory devices store instructions that, when executed by the respective processors, cause the processors to perform, in conjunction with, as appropriate, the other elements in and/or connected to the client device 1210 or server system 1250, each or any combination of actions described herein as performed by the component and/or by any software modules described herein as included within the component.

The hardware configurations shown in FIG. 7 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 7, (e) via other hardware arrangements, architectures, and configurations, and/or via combinations of the technology described in (a) through (e).

### Technical Advantages of Described Subject Matter

The technology described herein allows for efficient processing and interaction with certain API systems. In particular, the technology allows for the system to, among other aspects, dynamically change the network address associated with a system performing API calls against another API system. By performing API calls in this manner, the technology advantageously reduces the number of unnecessary requests made to the API system (e.g., as certain requests may be denied for being too frequent, or made by a specific network address within a specific period of time). The technology thus advantageously conserves processing resources of the system and improves network bandwidth by eliminating unnecessary requests made to the different API systems.

The technology described herein thus provides an easy-to-use user interface that includes a new and useful presentation of information, as well as a new and useful method for processing data compared to the conventional technology. Moreover, the improved user interface described herein provides a collection of views displaying various information associated with a system for monitoring gameplay data thus improving the overall human-computer interaction with the system.

### Selected Definitions

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

### Further Applications of Described Subject Matter

Although a number of references are made in this document to web applications, it should be understood that the features described herein may also be used, in various embodiments, in the context of other types of applications such as applications that are deployed/installed as binaries on client systems.

Although process steps, algorithms or the like, including without limitation with reference to FIGS. 1-7, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed

Moreover, it is not necessary for a device or method to address each and every problem sought to be solved by the present invention, for it to be encompassed by the invention. No embodiment, feature, element, component, or step in this document is intended to be dedicated to the public.

While the technology has been described in connection with what is presently considered to be an illustrative practical and preferred embodiment, it is to be understood that the technology is not to be limited to the disclosed embodiment, but on the contrary, is intended to cover various modifications and equivalent arrangements.

1. A system, comprising:
a server system having a processor and a memory; and
a client device having a processor and a memory, wherein
the server system is configured to:
create a first main process associated with a first video game;
create a first sub process associated with the first main process, wherein the first sub process includes one or more users participating in gameplay of the first video game;
using an application program interface associated with the first video game, monitor gameplay progress of the one or more users participating in the gameplay of the first video game;
generate values associated with each of the one or more users participating in the gameplay of the first video game based on the gameplay progress of each of the one or more users; and
generate user interface data associated the values of each of the one or more users participating in the gameplay of the first video game; and
transmit the user interface data to the client device, and
the client device is configured to:
receive the user interface data; and
generate a user interface for display using the user interface data.

2. The system of claim 1, wherein the server system monitors the gameplay progress of the one or more users through software calls of the application user interface operating in association with a gameplay server of the first video game.

3. The system of claim 1, wherein
each of the one or more users are associated with a respective user identification, and
the gameplay of the one or more users is monitored using the user identification of each of the one or more users.

4. The system of claim 1, wherein software calls using the application program interface are made within a specified interval of time.

5. The system of claim 1, wherein the values associated with each of the one or more users are scores reflecting the gameplay progress of each of the one or more users.

6. The system of claim 5, wherein
a first application program interface software call is conducted at a first time, wherein first scores are generated based on the gameplay progress at the first time;
a second application program interface software call is conducted at a second time, wherein second scores are generated based on the gameplay progress at the second time; and
total scores for each of the users are generated based on a difference between the first scores and the second scores.

7. The system of claim 1, wherein
the user interface includes a plurality of views, and
at least a first view, of the plurality of views, includes information associated with values associated with each of the one or more users participating in the gameplay of the first video game.

8. The system of claim 7, wherein at least a second view of the user interface includes information associated with participating in the first main process.

9. The system of claim 1, wherein
the first main process includes a tournament associated with the video game, and
the first sub process includes a pool of users participating in the tournament.

10. The system of claim 9, wherein the pool of users is confirmed a prize amount of the pool is greater than or equal to a minimum user threshold times a fee associated with each user.

11. A method for monitoring user gameplay, comprising:
at an information processing system having a processor and a memory:
creating a first main process associated with a first video game;
creating a first sub process associated with the first main process, wherein the first sub process includes one or more users participating in gameplay of the first video game;
monitoring gameplay progress of the one or more users participating in the gameplay of the first video game; and
generating values associated with each of the one or more users participating in the gameplay of the first video game based on the gameplay progress of each of the one or more users.

12. The method of claim 11, further comprising:
generating user interface data associated the values of each of the one or more users participating in the gameplay of the first video game.

13. The method of claim 11, wherein the gameplay progress of the one or more users participating in the gameplay of the first video game is monitored using an application program interface associated with the first video game.

14. The method of claim 11, wherein the values associated with each of the one or more users are scores reflecting the gameplay progress of each of the one or more users.

15. The method of claim 14, wherein
a first application program interface software call is conducted at a first time, wherein first scores are generated based on the gameplay progress at the first time;
a second application program interface software call is conducted at a second time, wherein second scores are generated based on the gameplay progress at the second time; and
total scores for each of the users are generated based on a difference between the first scores and the second scores.

16. A client device, comprising:
a processor; and
a memory configured to store computer readable instructions that, when executed by the processor, cause the client device to:
receiving user interface data from a server system; and
generating a user interface for display using the user interface data, wherein
the user interface includes at least a first view and a second view, and the first view includes:
a first portion including information for a first main process associated with a first video game, and
the second view includes:
a first portion including information having values associated with each of one or more users participating in gameplay of the first video game, wherein the values are generated based on gameplay progress of each of the one or more users.

17. The client device of claim 16, wherein the first view includes a second portion for a first sub process associated with the first main process, wherein the first sub process includes one or more users participating in gameplay of the first video game.

18. The client device of claim 17, wherein the gameplay progress is monitored using an application program interface associated with the first video game.

19. The client device of claim 17, wherein the values associated with each of the one or more users are scores reflecting the gameplay progress of each of the one or more users.

20. The client device of claim 19, wherein
a first application program interface software call is conducted at a first time, wherein first scores are generated based on the gameplay progress at the first time;
a second application program interface software call is conducted at a second time, wherein second scores are generated based on the gameplay progress at the second time; and
total scores for each of the users are generated based on a difference between the first scores and the second scores.
